(19) United States
(12) Patent Application Publication
(10) Pub. No.: US 2024/0003432 A1
(43) Pub. Date: Jan. 4, 2024

(54) Tree Gate Valve

(71) Applicant: Kinetic Pressure Control Ltd., Houston, TX (US)

(72) Inventors: Steven A. Angstmann, Houston, TX (US); Billy J. Gallagher, Houston, TX (US); Reese E. Jones, Houston, TX (US); Wade Sheppard, Houston, TX (US)

(73) Assignee: Kinetic Pressure Control Ltd., Houston, TX (US)

(21) Appl. No.: 18/367,449

(22) Filed: Sep. 12, 2023

Related U.S. Application Data
(63) Continuation-in-part of application No. PCT/US23/18749, filed on Apr. 15, 2023.
(60) Provisional application No. 63/335,642, filed on Apr. 27, 2022.
(60) Provisional application No. 63/458,641, filed on Apr. 11, 2023.

(51) Int. Cl. F16K 3/18; F16K 11/22; F16K 3/02

(52) U.S. Cl. CPC F16K 3/18; F16K 11/22; F16K 3/0281; F16K 3/029

(57) ABSTRACT

A valve with a body having a through bore for fluid passage. The body has a plurality of passages transverse to the through bore. At least two of the transverse passages each have a gate disposed therein configured for motion along the passage between a position to permit fluid flow along the through bore and a position to restrict fluid flow along the through bore. Each gate is configured for motion along the transverse passage in one direction in response to a first force acting on the gate and in another direction in response to a second force acting on the gate.

### CROSS REFERENCE TO RELATED APPLICATIONS

Continuation-in-Part of International Application No. PCT/US23/18749 filed Apr. 15, 2023, which claims priority from U.S. Provisional Application No. 63/335,642 filed Apr. 27, 2022, and 63/458,641 filed Apr. 11, 2023. All of the foregoing applications are incorporated herein by reference in their entirety.

### BACKGROUND

This disclosure relates to the field of mechanical valves. More specifically, the disclosure relates to gate valve designs for selective fluid communication in general applications.

Valves to control the transmission and flow of fluids have been in use for centuries. Gate valves are well known and applied in various industries. In oilfield operations (e.g., fracking, production applications), gate valves are commonly used to handle fluid flow at each well. Such valves are exposed to extremely harsh fluids (e.g., sand slurries) that significantly reduce the operational life of the gates. Conventional gate valves are designed with a stem and stem packing configuration, which is less than ideal for such applications. A typical gate valve applied in a fracking operation will require refurbishment approximately every two weeks during operation. This type of maintenance is time consuming and costly, often requiring shipment of the valve to a workshop for repair. Thus, a need remains for improved valve designs to handle various types of fluid transmission.

### SUMMARY

One aspect of the present disclosure is a valve including a body having a through bore for fluid passage. The body has a plurality of passages transverse to the through bore. At least two of the transverse passages each have a gate disposed therein configured for motion along the passage between a position to permit fluid flow along the through bore and a position to restrict fluid flow along the through bore. Each gate is configured for motion along the transverse passage in one direction in response to a first force acting on the gate and in another direction in response to a second force acting on the gate.

Another aspect of the present disclosure is a method of operating a valve having a body with a through bore for fluid passage and a plurality of passages transverse to the through bore. The method includes actuating a first gate disposed in a first passage transverse to the through bore for motion in one direction via a first force acting on the first gate and in another direction via a second force acting on the first gate; actuating a second gate disposed in a second passage transverse to the through bore for motion in one direction via a first force acting on the second gate and in another direction via a second force acting on the second gate. Actuation of the first gate and/or the second gate affects fluid flow along the through bore.

### DESCRIPTION OF THE DRAWINGS

FIG. 1 shows an oblique view of a valve embodiment according to this disclosure.

FIG. 2 shows a view of a gate cartridge in a valve embodiment according to this disclosure.

FIG. 3A shows a schematic of a valve embodiment in an open position according to this disclosure.

FIG. 3B shows the valve of FIG. 3A in a closed position according to this disclosure.

FIG. 4 shows an oblique transparency of valve embodiment according to this disclosure.

FIG. 5 shows a cross section view of a valve embodiment according to this disclosure.

FIG. 6 shows an overhead cutaway view of a valve embodiment according to this disclosure.

FIG. 7 shows a schematic of a valve spool embodiment according to this disclosure.

FIG. 8 shows a schematic of a valve embodiment with a removable end cap according to this disclosure.

FIG. 9 shows a valve embodiment disposed in a fluid system according to this disclosure.

FIG. 10 shows a schematic of another valve embodiment according to this disclosure.

FIG. 11 shows a cross section view of a valve embodiment according to this disclosure.

FIG. 12 shows the valve of FIG. 11 in a closed position according to this disclosure.

FIG. 13 shows a fluid/gas flow schematic of a valve embodiment according to this disclosure.

FIG. 14 shows a cross section view of another valve embodiment according to this disclosure.

FIG. 15 shows an overhead view of the valve of FIG. 14 according to this disclosure.

FIG. 16 shows another overhead view of the valve of FIG. 14 according to this disclosure.

FIG. 17 shows an oblique view of a valve embodiment according to this disclosure.

FIG. 18 shows another oblique view of the valve embodiment of FIG. 17.

FIG. 19 shows an exploded view of the valve embodiment of FIG. 18.

FIG. 20 shows a cross section side view of the valve embodiment of FIG. 17.

FIG. 21 shows an oblique view of a gate embodiment according to this disclosure.

FIG. 22 shows a close-up exploded view of a gate embodiment according to this disclosure.

FIG. 23 shows an oblique view of a gate embodiment according to this disclosure.

FIG. 24 shows a cross section side view of a gate embodiment according to this disclosure.

FIG. 25 shows an overhead cross section of a valve embodiment in an open position according to this disclosure.

FIG. 26 shows an oblique view of another gate embodiment according to this disclosure.

FIG. 27 shows a cross section side view of a gate embodiment with a solid surface according to this disclosure.

FIG. 28 shows an overhead cross section of a valve embodiment in a closed position according to this disclosure.

FIG. 29 shows an oblique exploded view of a valve embodiment according to this disclosure.

FIG. 30 shows a cross section plan view of a valve embodiment with a locking member according to this disclosure.

### DETAILED DESCRIPTION

Illustrative embodiments are disclosed herein. In the interest of clarity, not all features of an actual implementation may be described. In the development of any such actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure. The disclosed embodiments are not to be limited to the precise arrangements and configurations shown in the figures, in which like reference numerals may identify like elements. Also, the figures are not necessarily drawn to scale, and certain features may be shown exaggerated in scale or in generalized or schematic form, in the interest of clarity and conciseness.

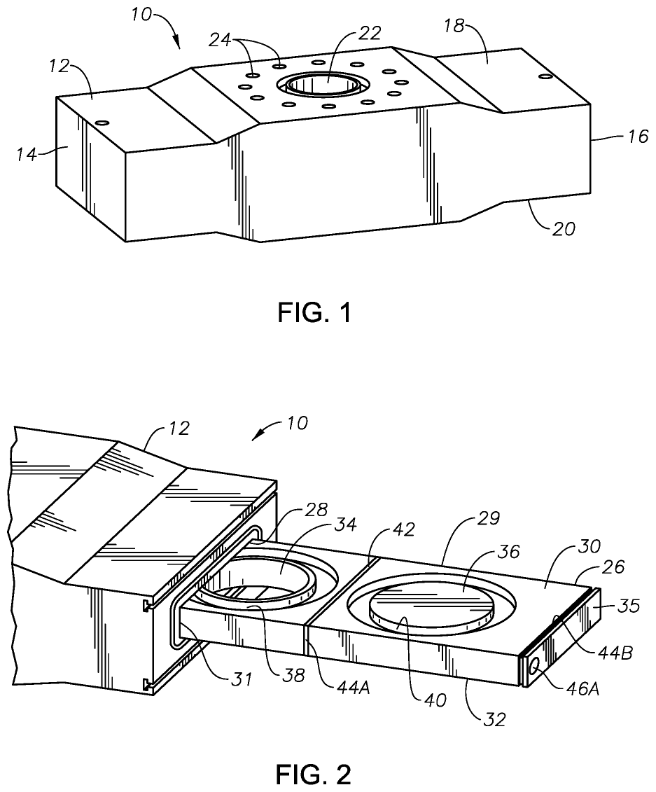

FIG. 1 shows a valve 10 embodiment according to this disclosure. The valve 10 has a main body 12, a first end 14, a second end 16, a first surface 18, and a second surface 20 opposite the first surface. A through bore 22 traverses through the body 12, providing an open passage between the first surface 18 and the second surface 20. Although the embodiment of FIG. 1 shows the through bore 22 configured as a cylindrical opening, the bore may be configured in other geometrical shapes as desired for the application (e.g., oval, octagonal, etc.). The body 12 may be formed of any suitable material depending on the application (e.g., metal, composites, plastics, synthetic materials, etc.). Although FIG. 1 shows an embodiment configured with a generally planar body 12 design, embodiments may be implemented with bodies comprising other geometrical designs more suitable for the desired application.

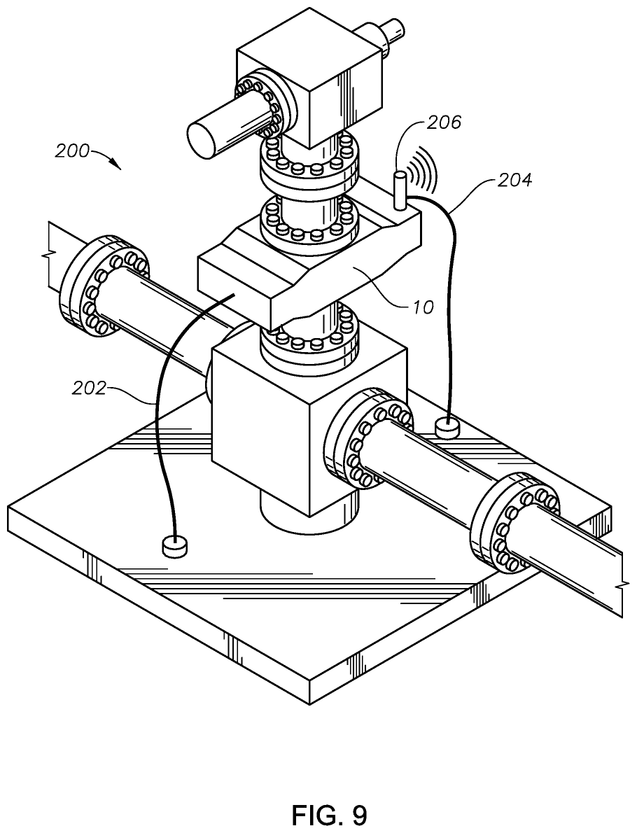

Some valve 10 embodiments may be configured with threaded holes 24 formed on each surface 18, 20 to receive mounting bolts for mounting of the valve 10 onto a fluid transmission system as known in the art (see FIG. 9). Embodiments may also be configured with the holes 24 passing through the entire body 12 for engagement of the valve 10 to flange units using extended length bolts. It will be appreciated by those skilled in the art that other embodiments may be configured for disposal of the valve 10 onto fluid lines or systems in various fashions depending on the application (e.g., welded onto a line, affixed with clamps, etc.).

FIG. 2 shows a view of a valve 10 embodiment according to this disclosure. The valve 10 is shown with a gate 26 extending out of a slot 28 formed within the body 12. In this embodiment, the gate 26 is configured as a rectangular-shaped planar body 29 with a first face 30 and a second face 32. The gate 26 has an opening 34 formed near a first end 31. The opening 34 is preferably shaped to coincide with the geometric shape of the through bore 22 formed in the valve 10 body. The gate 26 provides a solid surface area 36 near a second end 35. FIG. 2 shows the opening 34 surrounded by a seal trench 38. The other end with the solid surface area 36 also has a seal trench 40 formed thereon. Although not shown in FIG. 2, the second face 32 of the gate 26 is configured with matching seal trenches 38′, 40′. In essence, the first face 30 of the gate 26 is a mirror image of the second face 32.

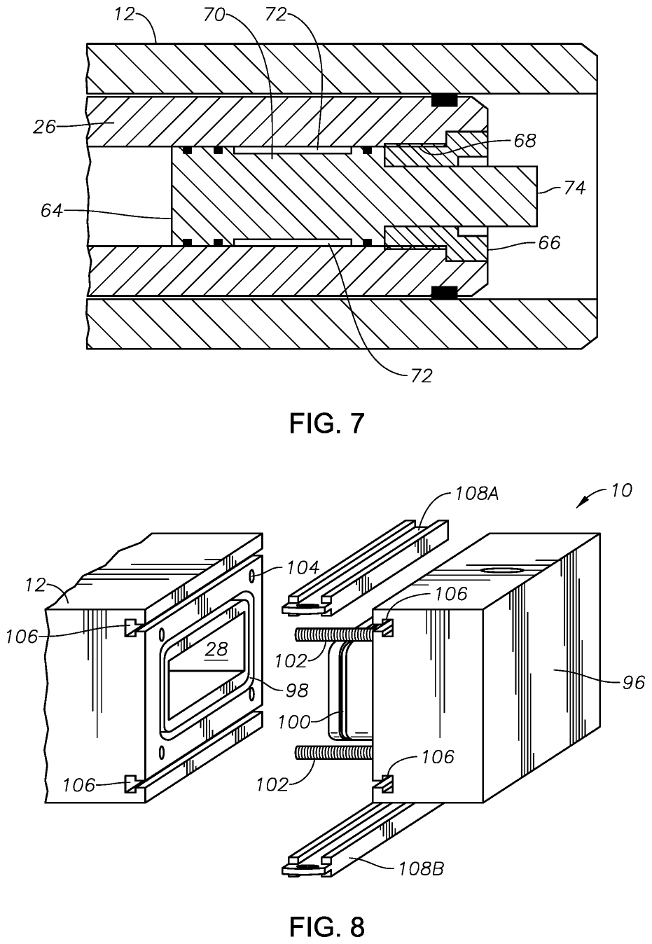

The gate 26 may be formed of any suitable material depending on the application (e.g., metal, composites, plastics, synthetic materials, etc.). As shown in FIG. 2, the gate 26 is disposed in the slot 28, which forms a passage transverse to the through bore 22 along the longitudinal axis of the valve 10 body 12 (see FIGS. 4, 5, 6). The gate 26 is formed to fit within the slot 28 at a close tolerance yet allowing the gate to move or slide within the slot as described below. As depicted in FIG. 2, the gate 26 is configured for easy insertion and extraction from the slot 28, akin to a cartridge in a player. This provides a notable advantage compared to conventional valve designs, which typically require removal of the entire valve for repair or refurbishment. Some embodiments may be implemented with a seal or band 42 (e.g., a rubber band) disposed in a groove 44A formed on the gate 26 surface near the center to provide a wiper for the internal surface of the slot 28 as the gate moves back and forth therein. Embodiments may also be implemented with additional wiper bands or seals disposed in other grooves 44B on the gate 26. FIG. 2 also shows the gate 26 configured with a threaded port 46A at one end (further described with respect to FIG. 7).

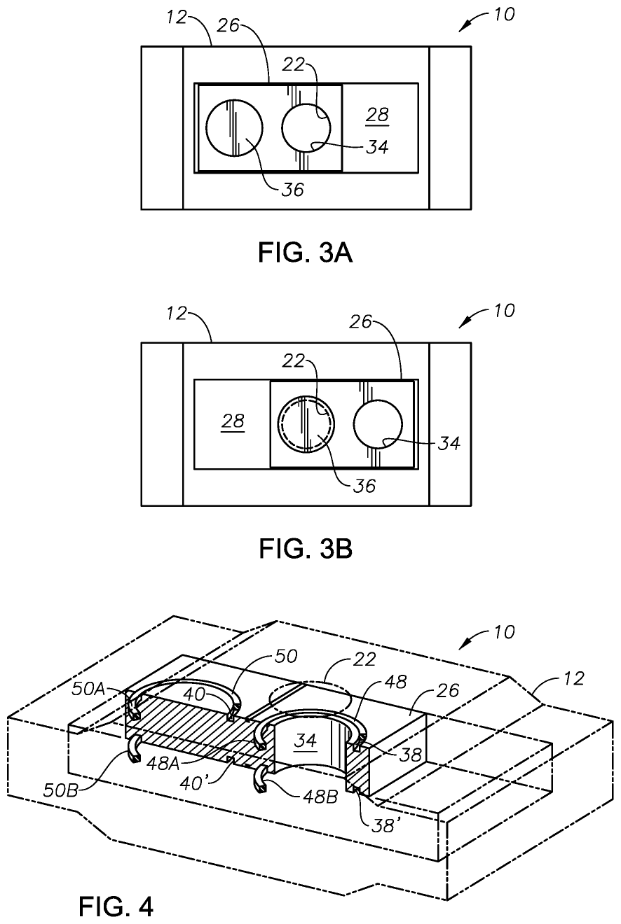

FIG. 3A shows an overhead cutaway schematic of a valve 10 embodiment of this disclosure. The gate 26 is shown in the open position, with the opening 34 coincident and aligned with the through bore 22. In this open position, any fluid traversing the through bore 22 from either the first face 30 or the second face 32 is free to flow through the gate 26 opening 34 and in-out through the valve 10.

FIG. 3B shows the valve 10 of FIG. 3A with the gate 26 in the closed position. When the gate 26 is moved (as described below) to the other end of the slot 28 compared to FIG. 3A, the solid surface area 36 of the gate 26 fully covers the through bore 22, preventing fluid passage therethrough.

Turning to FIG. 4, a transparency view of a valve 10 embodiment according to this disclosure is shown. The gate 26 is shown in the open position, as described with respect to the embodiment of FIG. 3A. In this embodiment, the gate 26 is configured with a first seal assembly 48 disposed at the gate opening 34 and a second seal assembly 50 disposed at the solid surface area 36 (see FIG. 2). First seal assembly 48 includes a first seal 48A disposed in the seal trench 38 formed on the first face 30 of the gate 26, and a second seal 48B disposed in a mirroring seal trench 38′ formed on the second face 32 of the gate (see description of FIG. 2). The second seal assembly 50 likewise includes a first seal 50A disposed in the seal trench 40 formed on the first face 30 of the gate 26, and a second seal 50B disposed in a mirroring seal trench 40′ formed on the second face 32 of the gate (see description of FIG. 2).

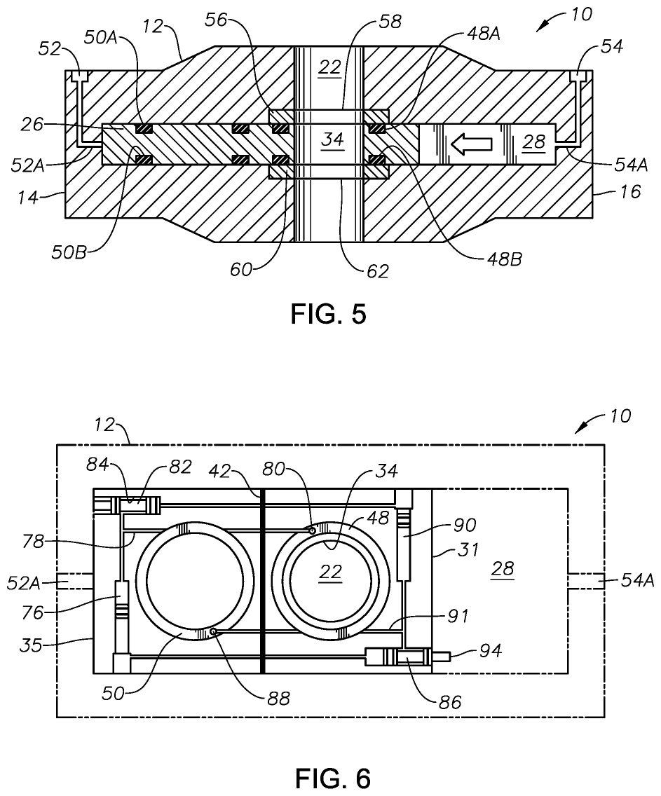

FIG. 5 shows a cross section of a gate 10 embodiment according to this disclosure. As depicted in FIG. 5, the first and second seal assemblies 48, 50 may be implemented with conventional radial seals 48A, 48B, 50A, 50B (see FIG. 4) to restrict fluid passage between the through bore 22 and the slot 28. Some embodiments may also be implemented with the seals 48A, 48B, 50A, 50B configured for energization to urge the respective seal faces against the surfaces to be sealed. Such seals are further described in Intl. Pat. Apps. WO20211142004 and WO20211141999, both assigned to the present assignee and incorporated herein by reference.

FIG. 5 also shows a first fluid port 52 leading to an internal fluid passage 52A that traverses the valve 10 body 12 to provide a fluid feed to the slot 28 at the first end 14. A second fluid port 54 is disposed at the second end 16 of the valve 10 and leads to another internal fluid passage 54A that traverses the valve body 12 to provide a fluid feed to the slot 28 at the second end. As shown in FIG. 5, the valve 10 is in the open position with the gate 26 abutting the slot 28 wall at the first end 14 of the valve. As described herein, in this position the gate 26 opening 34 coincides with the through bore 22, permitting fluid flow therethrough from either end across the valve 10 body 12. The gate 26 is set in the open position by maintaining a constant fluid pressure in the slot 28 at the second end 16 via fluid passage 54A, as depicted by the arrow in FIG. 5.

To close the valve 10, fluid is introduced under pressure through the first fluid port 52, via fluid passage 52A and into the slot 28 at the first valve 10 end 14. Simultaneously, fluid pressure is released from the slot 28 at the second end 16 via second fluid port 54. As fluid pressure at the first end 14 overcomes the pressure at the second end 16 of the slot 28, the gate 26 is pushed from the open to the closed position (left to right in the page). FIG. 3B shows a valve 10 with the gate 26 in the closed position. Although the first and second fluid ports 50, 52 are shown disposed at the first planar surface 18 of the valve 10, it will be appreciated that other embodiments may be implemented with the ports located at other surfaces (e.g., first end 14, second end 16, second planar surface 20, etc.) to facilitate mounting of the valve depending on the application.

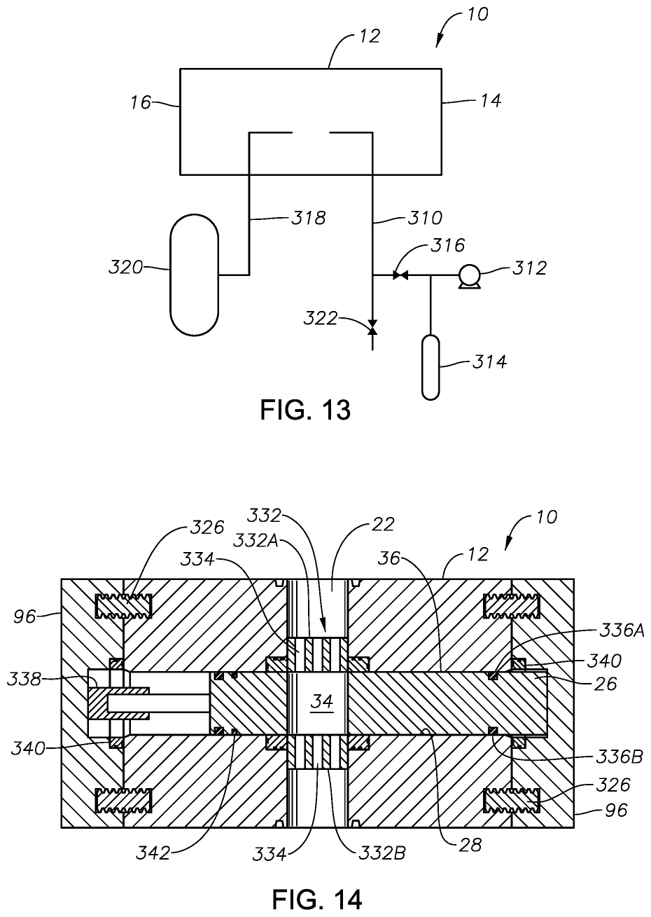

Fluid pressure to move the gate 26 from the open-to-closed position, and vice-versa, as described herein, may be provided by a separate pump and fluid (e.g., hydraulic fluid) reservoir system coupled to the first and second fluid ports 52, 54 (see FIGS. 9 and 13). As such, the valve 10 embodiments provide a closed system for the fluid to move the gate 26. FIG. 5 also shows a valve 10 embodiment configured with a first annular seat 56 disposed in a channel 58 formed in the body 12 above the gate 26 coincident with the through bore 22. A second annular seat 60 is disposed in another channel 62 formed in the body 12 below the gate 26 coincident with the through bore 22. The first and second annular seats 56, 60 may be formed of more durable materials (e.g., stainless steel, INCONEL™, ceramics, tungsten carbide, etc.) compared to the valve 10 body 12. Since sealing at the through bore 22/gate 26 junction is important to an efficient and effective valve 10, the annular seats 56, 60 provide a hardwearing corrosive-resistant surface to sustain a good seal via the seal assemblies 48, 50, particularly when implemented with energizable seals. In applications with fluids containing damaging or abrasive elements (e.g., sand contamination), the combination of seals 48, 50 and seats 56, 60 provides the necessary sealing to prevent migration of undesired contaminants internally within the valve 10. Placement of the seal assemblies 48, 50 on the gate 26 cartridge provides a significant advantage compared to conventional valves. Valves 10 configured with hardwearing annular seats 56, 60 can provide the required sealing ability for extended operation since the seal assemblies 48, 50 can be easily replaced in the field (without having to remove the valve 10 from the system) by extraction and refurbishment or replacement of the gate 26 cartridge as described herein.

Turning to FIG. 6, a transparency cutaway view of the top of a valve 10 embodiment according to this disclosure is shown. Valve 10 embodiments implemented with energizable radial seal assemblies 48, 50 entail the use of a pressurized fluid, gas, compounds, springs, or combinations of the aforementioned to energize the seals to provide a superior seal at the through bore 22/gate 26 junction. Usable seal embodiments include those described in Intl. Pat. Apps. WO20211142004 and WO20211141999. FIG. 6 shows a gate 26 embodiment configured with internal fluid passages to channel fluid to energize the seals disposed on the gate.

The valve 10 of FIG. 6 is shown in the open position, with the gate opening 34 coincident with the through bore 22. In this mode, the seals 48A, 48B of the first seal assembly 48 are energized up by fluid pressure provided by a reservoir of fluid (e.g., hydraulic fluid) fully contained within the gate 26. When the valve 10 is in the closed position, the second seal assembly 50 (on the left side of the page) is energized up. During the transition phase between open-close-open, the respectively engaged seals begin to de-energize, allowing the gate 26 to move while the other seals become energized.

The gate 26 is configured with two fluid timing circuits. Each circuit activates one of the seal assemblies 48, 50. Each circuit is implemented by a valve spool and a fluid reservoir interconnected via internal fluid passages disposed on the gate 26. FIG. 7 shows a cross section of a valve spool 64 embodiment according to this disclosure. The spool 64 is configured with a plug 66 that is threaded into an internal passage 68 within the gate 26 (e.g., via port 46A of FIG. 2). An internal plunger 70 provides an annular flow space 72 between sealed ends (e.g., via O-rings). When acted upon by fluid pressure or physical contact with the gate 26 body, the plunger 70 is free to move within the internal passage 68 in the gate. In one position, a distal end 74 of the plunger extends outward past the end of the gate 26 (see plunger 94 of FIG. 6).

Returning to FIG. 6, the valve 10 is in the open position, allowing unrestricted fluid passage through the gate 26 via the opening 34/through bore 22. In this open position, a first fluid reservoir 76 in the gate 26 provides hydraulic fluid under pressure (via a spring-piston unit) through a first internal fluid passage 78 that provides an outlet 80 at the seal trenches 38, 38′ (see FIG. 2) underneath each seal 48A, 48B to energize up each seal. In this position, the second end 35 of the gate 26 is pushed up against the valve body 12 wall by the fluid pressure applied to the first end 31 of the gate via internal fluid passage 54A. The distal end of a first valve spool 82 plunger is pressed into the receiving port 84 as the gate 26 abuts the body 12 wall. With the plunger in this position, the annular flow space provided by the plunger links the internal fluid passages as shown to allow fluid under pressure from the first fluid reservoir 76 to flow through the outlet 80 to energize up the seals 48A, 48B against the surfaces of the respective first and second annular seats 56, 60 (see FIG. 5).

The plunger on a second valve spool 86 is positioned to block fluid flow via the respective internal fluid passages leading to another outlet 88 at the seal trenches 40, 40′ of the other seals 50A, 50B (see FIG. 5) to keep those seals de-energized. When activating the gate 26 from the open position (as shown in FIG. 6) to the closed position by activation fluid pressure via internal fluid passage 52A, a second fluid reservoir 90 in the gate 26 commences drawing in the fluid through the internal passages 91 (via a spring-piston unit) to allow the fluid under the seals 48A, 48B to discharge into the reservoir, allowing the seals to de-energize and release sealing pressure against the annular seat 56, 60 surfaces. Simultaneously, as the gate 26 transitions to the closed position (left to right in the page), the other seals 50A, 50B begin to energize up via fluid pressure through the internal passages as the gate 26 moves to the closed position. When the gate 26 is in the fully closed position, with the first end 31 of the gate abutting against the valve body 12 wall (right side of FIG. 6), the extended distal end 94 of the second valve spool 86 will be pressed into the receiving port to allow maximum fluid flow under pressure from the second fluid reservoir 90 to flow through the outlet 88 to energize up the seals 50A, 50B against the surfaces of the annular seat 56, 60, while the other seals 48A, 48B are de-energized.

The disclosed fluid timing circuits channel the internal gate 26 fluids in this manner as the valve 10 cycles through open-closed sequences. The closed fluid system providing the fluid pressure to move the gate 26 back and forth via ports 52, 54 and the self-contained gate 26 fluid timing circuits in essence comprise a hydraulics-over-hydraulics closed system, which aids in keeping the fluids free of contaminants.

By maintaining a good seal while the valve 10 is set in the open or closed position and while the gate 26 is moving, maximum protection is provided against contaminant migration as the valve transitions. For example, when flowing fluids with high sand concentrations, the timed energization of the seal assemblies 48, 50 keeps the sand in the through bore 22 from migrating into the valve body 12. By preventing such ingress of debris into the valve 10 body the effective operational life of the valve is extended.

FIG. 8 shows a blowup of a valve 10 with a detachable end cap 96 embodiment according to this disclosure. As used herein for purposes of this disclosure, the words “detachment”, “detached”, and “detachable” are meant to encompass a component fully separated from other components as well as a component partially separated from other components (e.g., a hinged lid, hinged door, etc.). The valve 10 body 12 embodiment of FIG. 8 shows the body end configured with a seal groove 98 to receive a radial seal 100 (e.g., O-Ring) to maintain a sealed passage 28 for the gate 26. One or more guide pins 102 may also be inserted in holes 104 formed in the end cap 96 and the valve 10 body 12 to provide increased structural stability. Valve 10 embodiments may be implemented with one detachable end cap 96 disposed solely at one end thereof or with a pair of end caps, each mounted at an opposing end of the valve body. Embodiments implemented with a pair of end caps 96 facilitate the removal and insertion of the gate 26 from either end of the valve 10 body 12.

As shown in FIG. 8, an embodiment may be implemented with H-channels 106 formed transversely to the longitudinal axis of the body 12 on each end of the body and the end cap 96. When the end cap 96 is fitted against the valve 10 body, a pair of elongated I-bars 108A, 108B are used to maintain the cap in place. Each I-bar 108A, 108B is inserted from one side of the body 12 to slide into place for complementary engagement within the H-channels 106 formed on the cap 96 and body 12. The I-bars 108A, 108B may be secured in place by a conventional fastener. When it is desired to replace the gate 26 cartridge (e.g., to replace all the working seals), the I-bars 108A, 108B are pulled out of the H-channels 106 to free the end cap 96 for detachment to allow access to the gate via the passage 28. Once the end cap 96 is detached, the gate 26 cartridge can be removed and replaced while keeping the valve 10 in place. It will be appreciated by those skilled in the art that other detachable end cap 96 configurations may be implemented with the valves 10 using conventional hardware means and components.

FIG. 9 shows a valve 10 embodiment of this disclosure implemented in a fluid flow system 200 (e.g., an oilfield fracking operation). The fluid supply to move the gate 26 in the valve 10, as disclosed herein, may be provided via supply lines 202, 204 in the system 200. Other embodiments may be implemented with the valve 10 configured with its own independent fluid reservoir and pump unit to provide the required fluid pressure to the gate 26. Valve 10 embodiments may also be implemented with a conventional controller 206 and software as known in the art to activate the fluid flow to operate the gate 26. Some embodiments may also be implemented with a conventional antenna for wireless remote valve 10 activation via the controller 206.

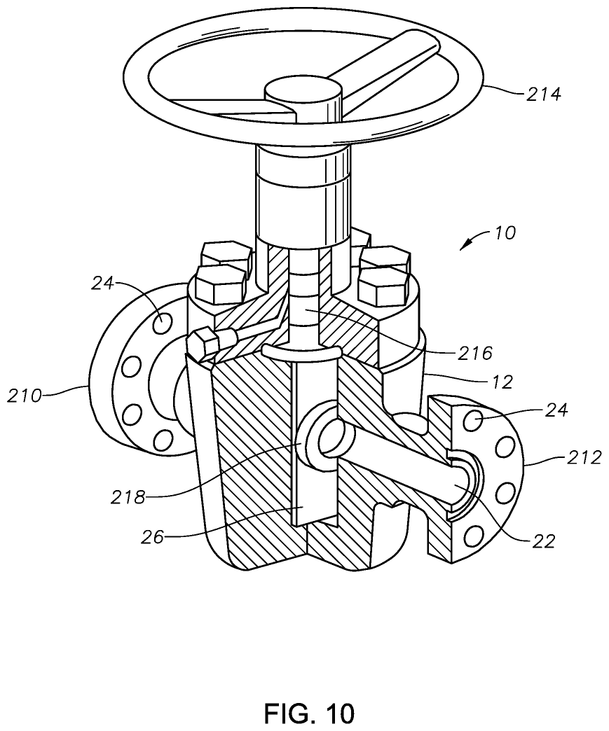

FIG. 10 shows another valve 10 embodiment according to this disclosure. It will be appreciated by those skilled in the art that the closed-fluid seal energization systems provided by the gate 26 embodiments disclosed herein are not limited to any particular operation or implementation. FIG. 10 shows an embodiment implemented with a conventional stemmed gate valve 10 design. The valve 10 is configured for manual operation to open-close the gate 26 to allow fluid passage via the through bore 22 across a first end 210 and a second end 212. A handle 214 is coupled to a stem 216, which is linked through the valve 10 body 12 to the gate 26. Rotation of the handle 214 causes the gate 26 to move between an open and closed position, selectively controlling fluid flow across the through bore 22. The gate 26 may be configured with the energizable seals 218 and features as disclosed herein.

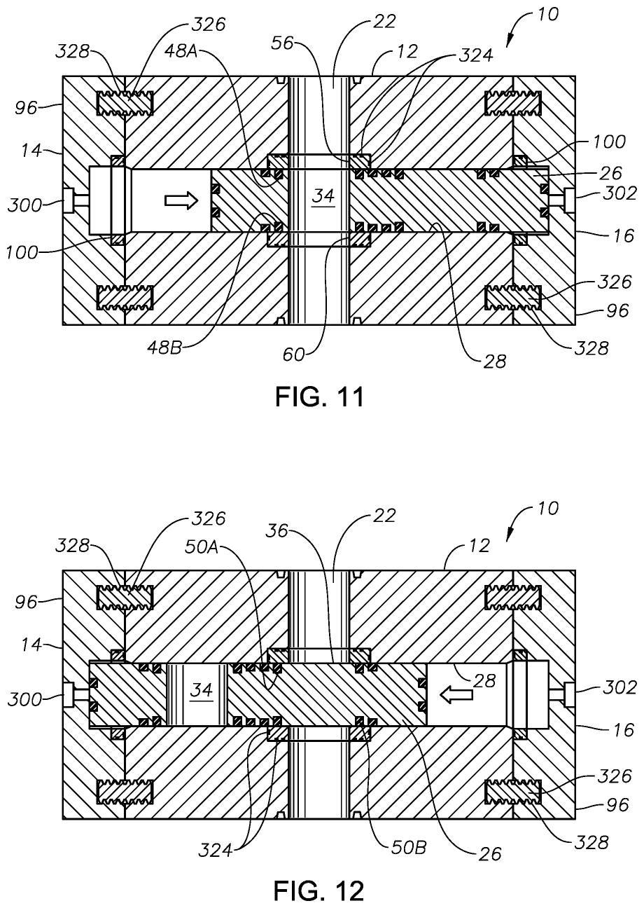

FIG. 11 shows a cross section of another valve 10 embodiment according to this disclosure. This embodiment is like the other embodiments disclosed herein. However, one difference is the application of different gate 26 activation forces. A first fluid port 300 leads to an internal fluid passage to provide a fluid feed to the slot 28 at the first end 14 of the body 12. When fluid (e.g., hydraulic fluid) is introduced under pressure via the port 300, the fluid pressure provides the motive force against the end of the gate 26 (depicted by the arrow in FIG. 11) to push the gate within the transverse passage 28. As shown in FIG. 11, the valve 10 is in the open position with the gate 26 abutting the slot 28 wall at the second end 16. As described herein, in this position the gate 26 opening 34 is coincident with the through bore 22, permitting fluid flow therethrough from either side across the valve 10 body 12. The gate 26 is set in the open position by maintaining a constant fluid pressure in the slot 28 at the first end 14 via fluid port 300. A second fluid port 302 is disposed at the second end 16 of the valve 10 and leads to another internal fluid passage to provide a fluid feed to the slot 28 at the second end. In some embodiments, the second port 302 is linked to a gas source to provide a pressurized gas motive force against the end of the gate 26 (depicted by the arrow in FIG. 12) to push the gate toward the first end 14 within the transverse passage 28.

FIG. 13 shows a schematic of the fluid system for the valve 10 embodiments depicted in FIGS. 11 and 12. When the valve 10 is in the open position (FIG. 11), the fluid feed 310 provides the motive force acting against the end of the gate 26 as described above. Fluid feed 310 is coupled to the first fluid port 300 (FIG. 11). The fluid may be provided via a conventional fluid pump 312 and/or a conventional accumulator 314. The pump 312 may be used to keep the accumulator 314 charged with fluid to a desired pressure. It will be appreciated by those skilled in the art that other pressurized fluid sources may be used to implement embodiments of this disclosure (e.g., remote fluid reservoirs/pumps, ROVs, etc.). A control valve 316 may be linked into the system to actuate fluid flow into the valve 10 via port 300 (see FIG. 11) to act on the gate, transitioning the valve to the open position as shown in FIG. 11. On the other side 16 of the valve 10, a pressurized gas feed 318 provides the motive force acting against the opposite end of the gate 26. Gas feed 318 is coupled to the second fluid port 302 (FIG. 11). A gas accumulator or gas bottle 320 may be linked to the feed 318 to provide the gas supply. Any suitable gas may be used depending on the application (e.g., conventional nonreactive gases). It will be appreciated by those skilled in the art that other pressurized gas sources may be used to implement embodiments of this disclosure (e.g., coupled remote gas reservoirs, ROVs, etc.). The fluid system also incorporates a vent valve 322 linked into the line on the first side 14 of the valve 10. Vented fluid may be diverted to a holding tank/reservoir coupled to the system.

Returning to FIG. 11, operation of the fluid system is described. When it is desired to actuate the valve 10 to the open position, fluid is introduced under pressure via port 300. The fluid is introduced with sufficient pressure to act against the end of the gate 26 (arrow in FIG. 11), overcoming the force of the gas acting on the opposite side of the gate. The gas on the opposite side of the gate is compressed and migrates to the accumulator or gas bottle 320. The valve 10 will remain in the open position provided the fluid feed 310 (see FIG. 13) maintains sufficient pressure against the gate 26 to overcome the gas feed 318 pressure on the opposite side of the gate.

FIG. 12 shows the valve 10 in the closed position. When it is desired to close the valve 10, the control valve 316 (see FIG. 13) is closed to stop fluid ingress via port 300 and vent valve 322 is opened. Once the vent valve 322 is opened, the fluid pressure on the gate 26 end drops very quickly. As the fluid pressure drops on the first end 14 of the gate 26, the compressed gas expands in the closed chamber supplied by the accumulator or gas bottle 320. As the gas expands, the pressure acts on the end of the gate 26 (arrow in FIG. 12) to shift the gate into the closed position. It will be appreciated that embodiments as disclosed in FIGS. 11 and 12 provide a fail-safe valve 10 whereupon the gate 26 automatically reverts to the closed position (via expanding pressurized gas feed 318) when fluid pressure drops or ceases via fluid feed 310. Embodiments may be implemented wherein the control valve 316 and/or the vent valve 322 (FIG. 13) may be actuated manually, remotely, and/or automatically and autonomously.

As with other embodiments of this disclosure, the embodiments of FIGS. 11 and 12 may be implemented with first and second annular seats 56, 60 disposed in the main body 12 as previously described. In Some embodiments, the annular seats 56, 60 may be configured with one or more radial/face seals 324 to provide greater sealing integrity. The valves 10 may also be configured with first and second seal assemblies 48, 50, which can be implemented with conventional radial seals 48A, 48B, 50A, 50B (see FIG. 4) to restrict fluid passage between the through bore 22 and the slot 28. Some embodiments may also be implemented with the seals 48A, 48B, 50A, 50B configured for energization to urge the respective seal faces against the surfaces to be sealed. Such seals are further described in Intl. Pat. Apps. WO20211142004 and WO20211141999. In some embodiments, the valves 10 may be configured for seal 48A, 48B, 50A, 50B energization via the expanding gas from gas feed 318 as described above.

As shown in FIGS. 11 and 12, some valve 10 embodiments may be implemented with elongated saw-tooth bars 326 that slide into complementary channels 328 formed transversely to the longitudinal axis of the body 12 on each end of the body and the end caps 96. When the end cap 96 is fitted against the valve 10 body, a pair of elongated saw-tooth bars 326 are used to maintain the cap in place. The saw-tooth bars 326 may be secured in place by a conventional fastener. When it is desired to replace the gate 26 cartridge (e.g., to replace all the working seals), the saw-tooth bars 326 are pulled out of the channels 328 to free the end cap 96 for detachment to allow access to the gate via the passage 28. Once an end cap 96 is detached, the gate 26 cartridge and/or the annular seats 56, 60 can be removed and replaced while keeping the valve 10 mounted in place.

FIG. 14 shows a cross section of another valve 10 embodiment according to this disclosure. This embodiment incorporates an annular insert 332 disposed within the main body 12, with a sleeve portion fitted coincident with the through bore 22. The insert 332 is configured in two sections 332A, 332B, with the sections fitted within the through bore 22 across from one another. Each insert section 332A, 332B includes one or more voids or openings 334 passing through the insert body to permit fluid passage through the insert body, and therefore across the through bore 22. As shown in the embodiment of FIG. 14, the openings(s) 334 may be configured as cylindrical passages traversing through the insert 332 body. The insert 332 embodiment of FIG. 14 includes a plurality of openings 334 aligned in parallel with the longitudinal axis of the through bore 22. Other insert 332 embodiments may be implemented with the openings 334 formed in different geometric configurations (e.g., oval, crescent, triangle, etc.) or with combinations of geometric shapes, all with the same dimensions or in varying dimensions. Some embodiments may be formed with the opening(s) 334 oriented or slanted with respect to the longitudinal axis of the through bore 22 (e.g., angled, spiral, or S-shaped channel). The openings 334 in the inserts 332 provide restriction channels that help diffuse and control fluid flow via the valve 10 through bore 22, particularly in high-pressure fluid flow applications. The inserts 332 may be formed of any suitable material depending on the application (e.g., metal, composites, plastics, synthetic materials, etc.). The insert sections 332A, 332B may be easily removed and swapped to provide different diffusion effects by freeing an end cap 96 and removing the gate 26 as described herein.

As shown in FIG. 14, some valve 10 embodiments may be configured with the gate 26 having one seal assembly 336A, 336B to provide sealing for both the gate opening 34 and the solid surface area 36 when the gate is in the closed position. FIG. 14 shows the valve 10 in the open position. The seal assembly 336A, 336B may be implemented with conventional radial seals to restrict fluid passage between the through bore 22 and the slot 28, or with seals configured for energization to urge the respective seal faces against the surfaces to be sealed (e.g., as described in Intl. Pat. Apps. WO20211142004 and WO20211141999). Valve 10 embodiments of this disclosure may also be implemented with conventional or energizable radial/face seal carriers 340 disposed between the end caps 96 and main body 12 junctions.

The valve 10 embodiment of FIG. 14 is also implemented with an actuator 338 linked to the gate 26 to provide the motive force to move the gate along the transverse passage 28 between the open and closed positions. The actuator 338 is linked to one end of the gate 26. Conventional actuators 338 may be used to implement valve 10 embodiments in accordance with this disclosure (e.g., EXLAR™ linear rotor screw actuators, hydraulic actuators, servos, etc.). Containment of the actuator 338 inside the valve 10 body 12 avoids the need for shaft seals, which prevents fugitive emissions (e.g., sand slurry and other substances entering the cavity between the gate and the body during service). Such embodiments provide a low-activation force and balanced gate valve 10. When the valve 10 is to be opened, the actuator 338 is activated to apply a compressive or pushing force against the gate 26 (to the right in FIG. 14). When the valve 10 is to be closed, the actuator 338 is activated to apply a tension or pulling force on the gate 26 (to the left in FIG. 14). Power and/or fluid pressure for the actuator 338 may be provided via any suitable means as known in the art. Some embodiments may also be implemented with a wiper seal 342 disposed on the gate 26 near the end closest to the actuator 338.

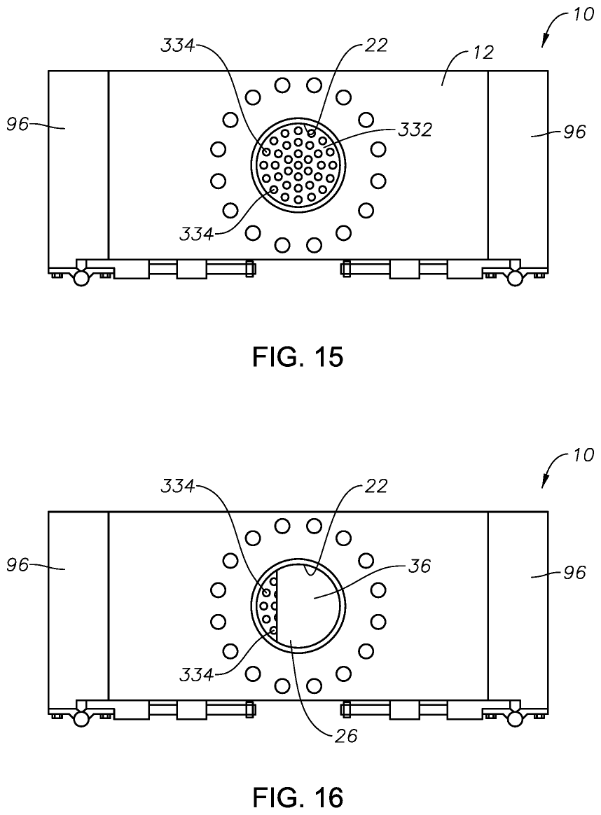

FIG. 15 shows an overhead view of the valve 10 of FIG. 14 with the gate 26 in the fully open position. In this mode, fluid flow via the through bore 22 is diffused by the plurality of openings 334 in the insert 332. FIG. 16 shows an overhead view of the valve of FIG. 14 with the gate 26 in a near closed position. In this mode, fluid flow via the through bore 22 is restricted by the gate 26 and diffused by the uncovered openings 334 in the insert 332. The actuator 338 may be activated to move the gate 26 within the passage 28 to any desired position between fully closed and fully open.

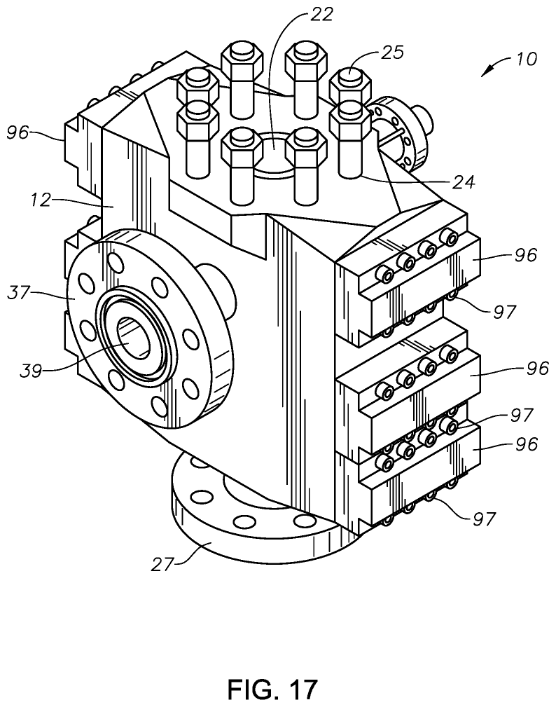

FIG. 17 shows another valve 10 embodiment according to this disclosure. The valve 10 has an elongated main body 12 with a through bore 22 providing an open passage from one end to the other. The body 12 may be formed of any suitable material depending on the application (e.g., metal, composites, plastics, synthetic materials, etc.). Although FIG. 17 shows an embodiment configured with a generally planar body 12 design, embodiments may be implemented with bodies comprising other geometrical designs more suitable for the desired application. Some valve 10 embodiments may be configured with threaded holes 24 formed on one end to receive mounting bolts 25 for mounting of the valve onto a fluid transmission system as known in the art (see FIG. 9). The valve 10 is shown configured with a mounting flange 27 extending from the other end of the through bore 22. This valve 10 is also configured with a mounting flange 37 on one side of the body 12. This additional flange 37 leads to a port 39 formed in the body 12 (further described below). It will be appreciated by those skilled in the art that other valve 10 embodiments may be configured for disposal or mounting onto fluid lines or systems in various fashions depending on the application (e.g., welded onto a line, affixed with clamps, etc.). FIG. 17 shows the valve 10 configured with multiple detachable end caps 96 mounted to the body via stud/nut 97 fasteners.

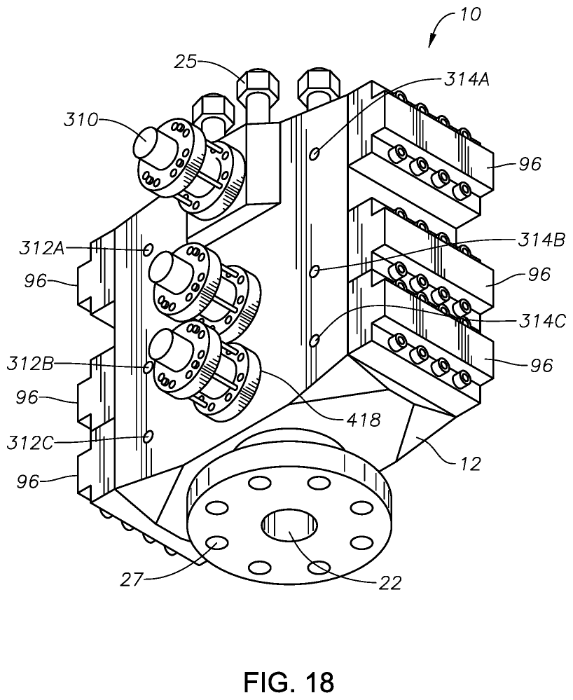

FIG. 18 shows the valve 10 of FIG. 17 from the side opposite the side implemented with flange 37. The valve 10 embodiments of this disclosure may also be implemented with a locking element 310 (further described below). The embodiment of FIG. 18 is configured with three separate locking elements 310. As shown in FIG. 18, some embodiments may also be configured with a series of orifices 312A, 312B, 312C formed proximate one side of the body 12, and another series of orifices 314A, 314B, 314C formed proximate the opposite side of the body (further explained below).

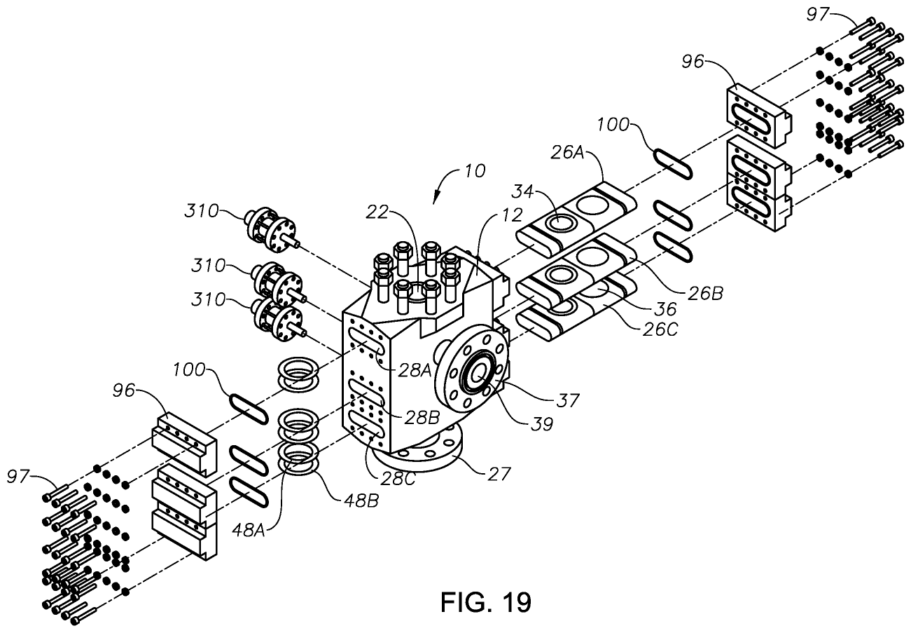

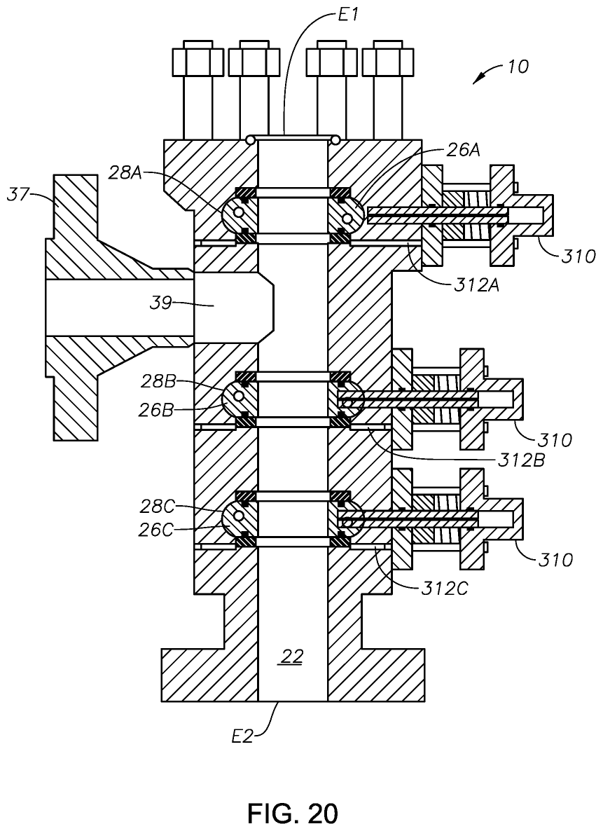

FIG. 19 shows an exploded view of the valve 10 embodiment of FIG. 18. As shown, the body 12 is configured with a series of slots 28A, 28B, 28C forming individual passages transverse to the through bore 22 and running across the body 12 from one end to the other. Each slot 28A, 28B, 28C is configured to house a respective gate 26A, 26B, 26C. FIG. 20 shows a side cross section of the valve 10 embodiment of FIG. 19. As shown in FIG. 20, the side port 39 formed in the body 12 extends through the body to fluidly link into the through bore 22. The port 39 is formed to reside in between two of the transverse slots 28A, 28B housing respective gates 26A, 26B.

As can be seen from the cross section of the valve 10 in FIG. 20, fluid flow via through bore 22 can be directly affected by activation of the gates 26A, 26B, 26C. For purposes of discussion, it will be understood that fluid flow via the valve 10 will occur when the valve is coupled into a conventional fluid transmission system (e.g., production line in oil and gas applications). If fluid flow is desired solely via the though bore 22 (into or out of either end), gates 26A, 26B, 26C are actuated to the open position as described herein and any flow via port 39 is closed off at the other end of the flange 37. If fluid flow is desired between the port 39 and a first end E1 of the through bore 22, gate 26A is actuated to the open position and gates 26B and/or 26C are actuated to the closed position as described herein. If fluid flow is desired between the port 39 and a second end E2 of the through bore 22, gate 26A is actuated to the closed position and gates 26B and 26C are actuated to the open position as described herein. If there is a failure in the shut off system at the other side of the flange 37, gates 26A and 26B and/or 26C can be actuated to the closed position to contain and close off any incoming flow via port 39. Closure of gates 26A and 26B and/or 26C also shuts off any fluid flow from either end E1, E2 of the through bore 22. FIG. 20 also shows the ports leading into the body 12 from orifices 312A, 312B, 312C.

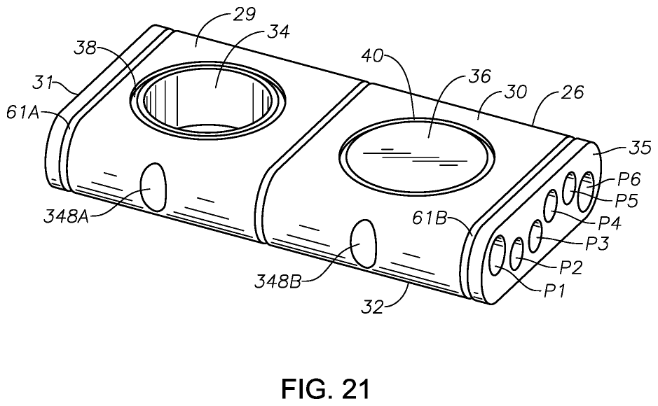

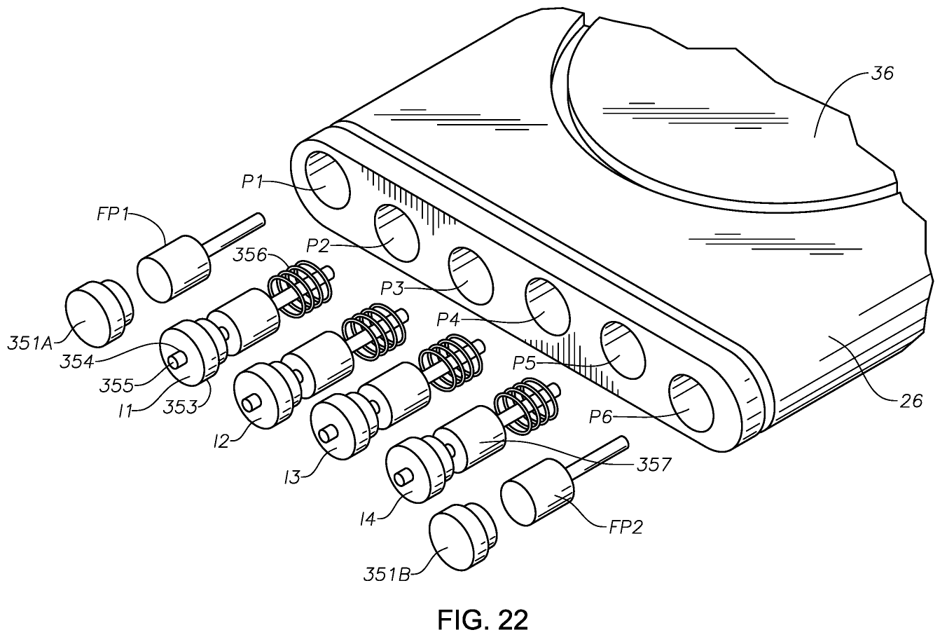

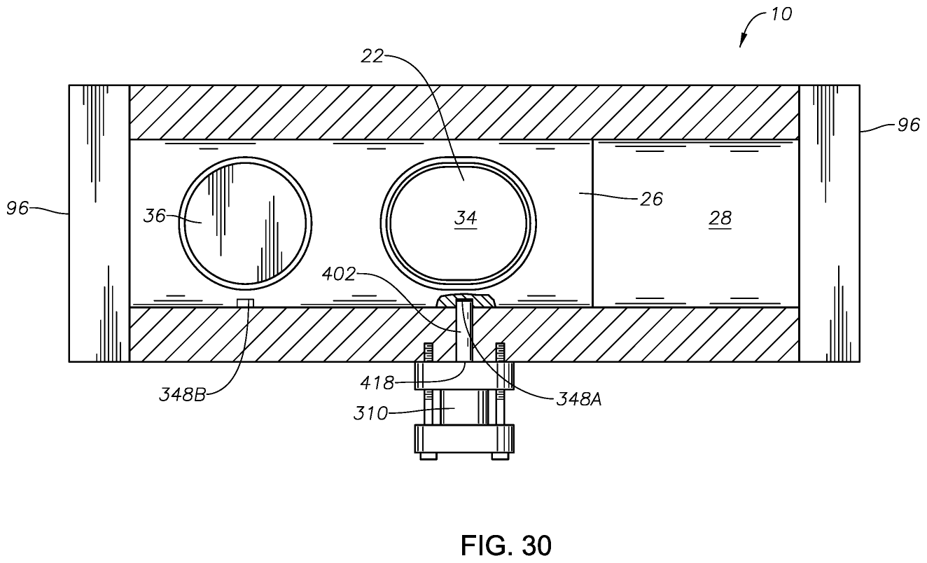

FIG. 21 shows another embodiment of a gate 26 in accordance with this disclosure. Some gate 26 embodiments may be implemented with one or more grooves 61A, 61B formed encircling the gate surface near each end to receive and hold a band (e.g., an O-ring). Such bands function as a wiper for the internal surface of the respective transverse passage as the gate 26 moves back and forth therein. FIG. 21 shows a gate 26 embodiment configured with ports P1, P2, P3. P4, P5, P6 at one end (further described with respect to FIG. 22). FIG. 21 also shows an embodiment implemented with a pair of orifices 348A, 348B formed on one side of the gate 26 (further described with respect to FIG. 30).

FIG. 22 shows a close-up of a gate 26 embodiment from the end near the solid surface area 36. Ports P1 and P6 are configured to respectively receive floating pistons FP1 and FP2. Caps 351A and 351B are threadably engaged on the ports P1, P6 to respectively secure the pistons FP1, FP2 and seal the ports. The pistons FP1, FP2 and caps 351A, 351B may be fitted with seals (e.g., O-rings) to provide greater sealing integrity. Ports P2, P3, P4, and P5 are configured to respectively receive intensifier elements I1, I2, I3, and I4. Each intensifier element incorporates a threaded cap 353 with a hole 354, a plunger 355, and a spring 356. The plungers 355 include a body portion 357 affixed with an extending rod that passes through the hole 354 in the cap 353. The plunger 355 body portions 357 and caps 353 may be fitted with seals (e.g., O-rings) to provide greater sealing integrity.

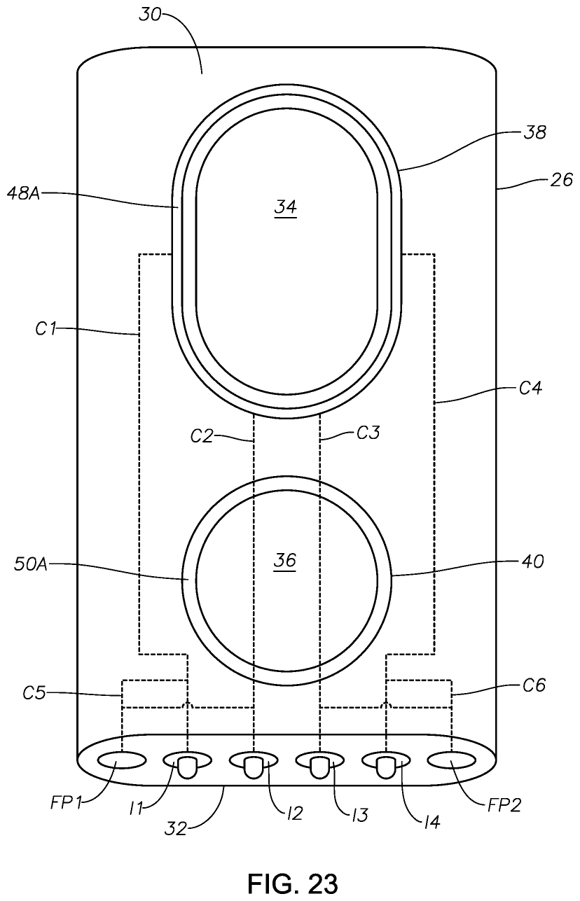

FIG. 23 shows a gate 26 embodiment of this disclosure. The gate 26 is implemented with the floating pistons FP1, FP2 and intensifier elements I1, I2, I3, I4 as described with respect to FIG. 22. As previously described with respect to the embodiment of FIG. 4, the gate 26 may be configured with mirroring seal trenches 38, 38′, 40, 40′ respectively formed on each face 30, 32. A first seal 48A is disposed around gate opening 34 in seal trench 38 and a second seal 50A is disposed around the solid surface area 36 in seal trench 40 (see FIG. 22). Although not depicted in FIG. 23 for clarity of illustration, a third seal 48B is disposed in mirroring seal trench 38′ formed on the second face 32 of the gate 26 surrounding the opening 34. Similarly, a fourth seal 50B is disposed in mirroring seal trench 40′ formed on the second face 32 of the gate 26 around the solid surface area 36.

FIG. 23 also shows the internal gate 26 passages for fluid circuits between the seals 48A, 48B, 50A, 50B, the intensifier elements I1, I2, I3, I4, and the floating pistons FP1, FP2. Internal fluid channels C1 and C2 respectively traverse through the gate 26 body between seal trench 38 and intensifier elements I1 and I2. Internal fluid channels C3 and C4 respectively traverse through the gate 26 body between seal trench 38′ and intensifier elements I3 and I4. Internal fluid channels C5 and C6 respectively traverse through the gate 26 body to link internal passages C1 and C2 with floating piston FP1 and internal passages C3 and C4 with floating piston FP2. All the channels form internal closed fluid circuits in the gate 26.

Returning to FIG. 22, the closed fluid circuits of FIG. 23 are further described. Cap 351A seals channel C5, which is filled with inert gas (e.g., Nitrogen) under pressure. Cap 351B similarly seals channel C6, which is also filled with inert gas under pressure. The caps 353 of intensifier elements I1 and I2 respectively seal channels C1 and C2, which are linked at the other end to seal trench 38. Channels C1 and C2 are filled with a semi-solid compound (e.g., high viscosity or thixotropic fluid, such as a suitable grease or other conventional semi-solid compound). Caps 353 of intensifier elements I3 and I4 respectively seal channels C3 and C4, which are linked at the other end to seal trench 38′ on the gate 26 (not shown in FIG. 23 for clarity of illustration). Channels C5 and C6 are respectively linked into channels C1, C2 and C3, C4.

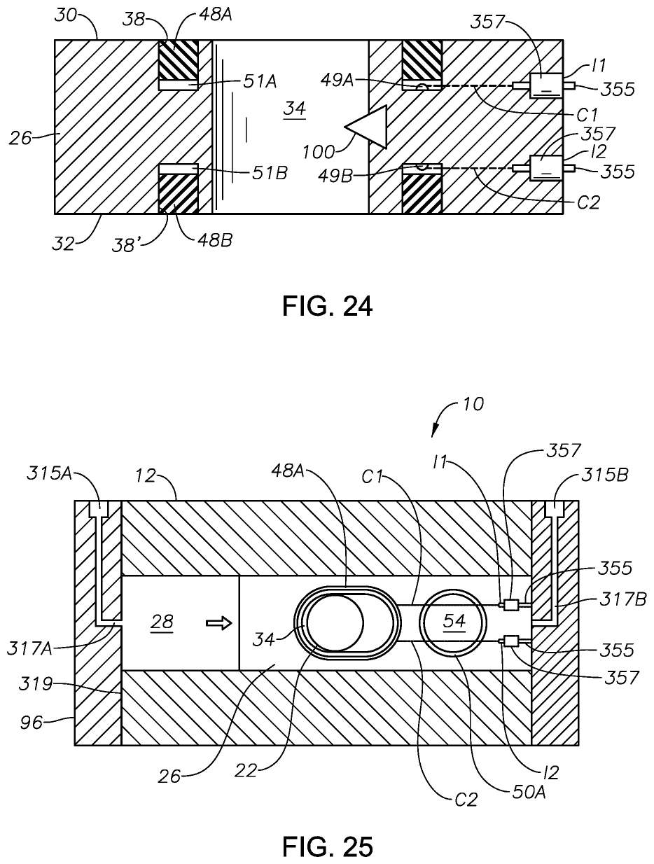

FIG. 24 shows a cross section side view of a gate 26 embodiment similar to the embodiment of FIG. 23. For clarity of illustration, only the section of the gate 26 with opening 34 is shown in FIG. 24. Seal 48A resides in seal trench 38 on the first face 30 of the gate and seal 48B resides in seal trench 38′ on the second face 32. Each seal trench 38, 38′ is respectively configured with an orifice 49A, 49B at the bottom of the trench. Internal fluid channel C1 runs between orifice 49A and intensifier element I1. Internal fluid channel C2 runs between orifice 49B and intensifier element I2. The gate 26 is shown with the seals 48A, 48B in a neutral or de-energized state. In this state, the seals 48A, 48B reside in the trenches 38, 38′ without any pressure from the intensifier elements I1, I2, I3, I4 imposed upon them. As shown in FIG. 24, each trench 38, 38′ provides spacing 51A, 51B for the seals 48A, 48B to move slightly up or down within the trench. In the de-energized state, each intensifier element I1, I2 plunger 355 extends out from the side of the gate 26 as shown in FIG. 24.

Turning to FIG. 25, a valve 10 with a gate 26 embodiment similar to the embodiment of FIG. 24 is shown. In this overhead cross section view, the gate 26 is shown transitioned to an energized state, wherein seals 48A and 48B (see FIG. 24) are energized by the internal fluid circuits when the gate is positioned with the opening 34 coincident with the main body 12 through bore 22. In this embodiment, the cover 96 at one end of the body 12 includes a fluid port 315A leading to an internal fluid passage 317A that leads to a fluid feed into the transverse passage 28. The cover 96 at the second end of the body 12 is also configured with a fluid port 315B leading to an internal fluid passage 317B that leads to a fluid feed into the transverse passage 28 at the other end of the gate 26. As shown in FIG. 25, the valve 10 is in the open position. In this open position, any fluid traversing the through bore 22 from either end is free to flow through the gate opening 34 and in-out through the valve 10. The gate 26 is set or actuated in the open position by maintaining a constant fluid pressure in the transverse passage 28 at a first end 319 via fluid passage 317A, as depicted by the arrow in FIG. 25.

When the gate 26 is pushed via fluid pressure to the far end of the passage 28 (to the right in FIG. 25), the gate end abuts the inner surface of the cover 96 as shown in FIG. 25. The plunger 355 rods on the intensifier elements I1, I2 are then pushed inward, overcoming the spring 356 force, and causing the plunger body portions 357 to move inward within the ports (see FIG. 22). The body portions 357 function as pistons, pressurizing the semi-solid compound within the channels C1, C2. At the other end of the channels C1, C2 the pressurized semi-solid compound exits the orifices 49A, 49B in the seal trenches 38, 38′, energizing the seals 48A, 48B to engage with the inner surfaces of the transverse passage 28. In this manner, the energized seals 48A, 48B provide an effective barrier to restrict fluids traversing the through bore 22 from seeping into the transverse passage 28.

Although the gate 26 embodiments of FIGS. 24 and 25 are shown without the floating pistons FP1, FP2 for clarity of illustration, it will be appreciated that any gate embodiment of this disclosure may be implemented with or without such elements. Operation of the gate 26 of FIG. 25 is now considered with the embodiments of FIGS. 23 and 24. As described above, the floating pistons FP1, FP2 cap internal gate 26 channels C5, C6 that are filled with an inert gas under pressure. As shown in FIG. 23, channels C5 and C6 respectively internally link into channels C1, C2 and C3, C4. In this manner, the inert gas maintains a constant compressive pressure head on the semi-solid compound within the respective channels C1, C2, C3, C4, which in turn maintains a constant pressure on the seals 48A, 48B. By maintaining a constant pressure on the seals 48A, 48B they remain in a semi-energized state and as the seals are extruded, they are fed over time to maintain a sealing pressure.

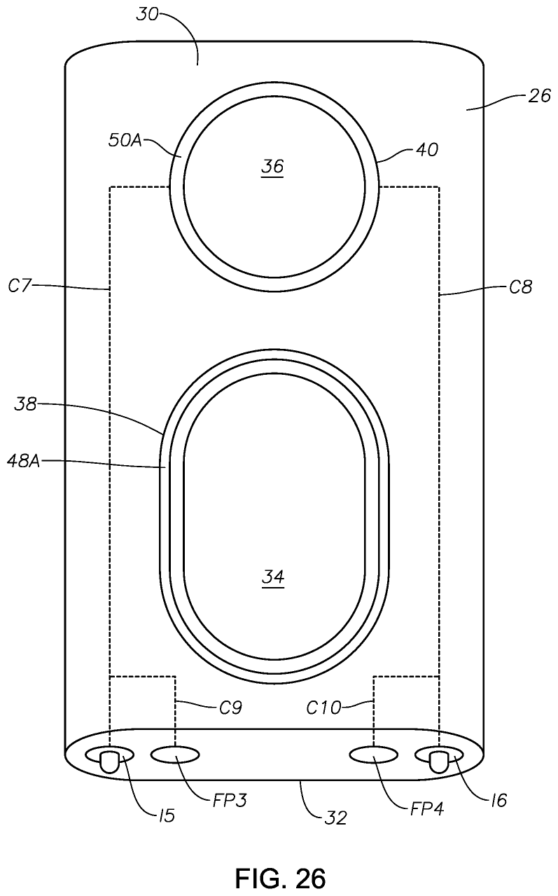

FIG. 26 also shows the internal gate 26 passages for the fluid circuits between the seals 50A, 50B, intensifier elements I5, I6, and floating pistons FP3, FP4. Internal fluid channel C7 traverses through the gate 26 body between seal trench 40 and intensifier element I5. Internal fluid channel C8 traverses through the gate 26 body between seal trench 40′ and intensifier element I6. Internal fluid channel C9 traverses through the gate 26 body to link internal passage C7 with floating piston FP3 and internal passage C10 to link internal passage C8 with floating piston FP4. All the channels form internal closed fluid circuits in the gate 26. Seal channels C7 and C8 are filled with a semi-solid compound similar to the gate 26 embodiment of FIG. 23. Intensifier element I5, I6, and channels C9 and C10 are likewise filled with inert gas under pressure.

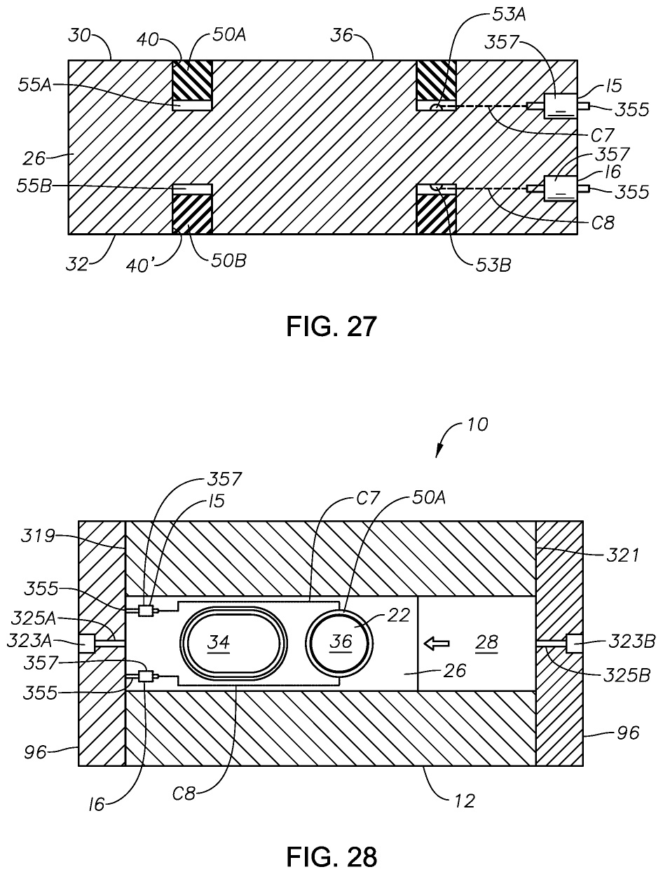

FIG. 27 shows a cross section side view of a gate 26 embodiment similar to the embodiment of FIG. 26. For clarity of illustration, only the gate 26 section with the solid surface area 36 is shown in FIG. 27. Seal 50A resides in seal trench 40 on the first face 30 of the gate and seal 50B resides in seal trench 40′ on the second face 32. Each seal trench 40, 40′ is respectively configured with an orifice 53A, 53B at the bottom of the trench. Internal fluid channel C7 runs between orifice 53A and intensifier element I5. Internal fluid channel C8 runs between orifice 53B and intensifier element I6. The gate 26 is shown with the seals 50A, 50B in a neutral or de-energized state. In this state, the seals 50A, 50B reside in the trenches 40, 40′ without any pressure from the intensifier elements I5, I6 imposed upon them. As shown in FIG. 27, each trench 40, 40′ provides spacing 55A, 55B for the seals 50A, 50B to move slightly up or down within the trench. In the de-energized state, each intensifier element I5, I6 plunger 355 extends out from the side of the gate 26 as shown in FIG. 27.

Turning to FIG. 28, a valve 10 with a gate 26 embodiment similar to the embodiment of FIG. 27 is shown. In this overhead cross section view, the gate 26 is shown transitioned to an energized state, wherein seals 50A and 50B (see FIG. 27) are energized by the internal fluid circuits when the gate is positioned with the solid surface area 36 coincident with the main body 12 through bore 22. In this embodiment, the cover 96 at the second end 321 includes a fluid port 323B leading to an internal fluid passage 325B that leads to a fluid feed into the transverse passage 28. The cover 96 at the first end 319 is also configured with a fluid port 323A leading to an internal fluid passage 325A that leads to a fluid feed into the transverse passage 28 at the other end of the gate 26. As shown in FIG. 28, the valve 10 is in the closed position with the gate 26 solid surface area 36 not permitting fluid flow through the through bore 22. The gate 26 is set in the closed position by maintaining a constant fluid pressure in the transverse passage 28 at the second end 321 via fluid passage 325B, as depicted by the arrow in FIG. 28.

When the gate 26 is pushed via fluid pressure to the far end of the passage 28 (to the left in FIG. 28), the gate end abuts the inner surface of the cover 96 as shown in FIG. 28. The plunger 355 rods on the intensifier elements I5, I6 are then pushed inward, overcoming the spring 356 force, and causing the plunger body portions 357 to move inward within the ports (see FIG. 22). The body portions 357 function as pistons, pressurizing the semi-solid compound within the channels C7, C8. At the other end of the channels C7, C8 the pressurized semi-solid compound exits the orifices 53A, 53B in the seal trenches 40, 40′, energizing the seals 50A, 50B to engage with the inner surfaces of the transverse passage 28. In this manner, the energized seals 50A, 50B provide an effective barrier to restrict fluids in the through bore 22 from seeping into the transverse passage 28.

Although the gate 26 embodiments of FIGS. 27 and 28 are shown without the floating pistons FP3, FP4 for clarity of illustration, it will be appreciated that any gate embodiment of this disclosure may be implemented with or without such elements. Operation of the gate 26 of FIG. 28 is now considered with the embodiments of FIGS. 26 and 27. As described above, the floating pistons FP3, FP4 cap internal gate 26 channels C9, C10 that are filled with an inert gas under pressure. As shown in FIG. 26, channels C9 and C10 respectively link internally into channels C7 and C8. In this manner, the inert gas maintains a constant compressive pressure head on the semi-solid compound within the respective channels C7, C8, which in turn maintains a constant pressure on the seals 50A, 50B. By maintaining a constant pressure on the seals 50A, 50B they remain in a semi-energized state and as the seals are extruded, they are fed over time to maintain a sealing pressure.

As disclosed herein, embodiments of the valve 10 are configured to channel fluid to actuate the gate 26 from the open position to the closed position and vice-versa. While some valve 10 embodiments are configured with fluid ports on the end caps 96, other embodiments may be implemented with the ports to channel the gate 26 actuation fluids in other locations. For example, as disclosed in the embodiment of FIG. 18, the fluid ports may be formed on the valve 10 body 12 to provide a first fluid pressure force to the gate(s) 26 in one direction 312A, 312B, 312C, and a second fluid pressure force in an opposing direction 314A, 314B, 314C. FIG. 20 shows the ports leading into the body 12 from orifices 312A, 312B, 312C. Fluid under pressure can be provided to the ports (e.g., 312A, 312B, 312C, 314A, 314B, 314C) via conventional means as known in the art (e.g., hoses coupled to the ports from a pressurized fluid source such as a pump).

It will be appreciated that gate 26 embodiments of this disclosure may be implemented with conventional seals, with energizable seals, or with a combination of conventional and energizable seals. It will also be appreciated that gate 26 embodiments may be implemented with zero, one, or multiple floating pistons as well as with zero, one, or multiple intensifier elements as disclosed herein. An advantage of embodiments implemented with energizable seals as disclosed is the automatic and autonomous energization and de-energization of the seals upon transition of the valve 10 from an open position to a closed position and vice-versa. The fluid ports providing the fluid pressure to move the gates 26 back and forth and the self-contained internal gate 26 fluid circuits in essence comprise a hydraulics-over-hydraulics closed system, which aids in keeping the fluids free of contaminants. By maintaining a good seal while the valve 10 is set in the open or closed position and while the gate 26 is moving, maximum protection is provided against contaminant migration as the gates transition. For example, when flowing fluids with highly abrasive concentrations, energization of the gate 26 seals keeps the abrasive material in the through bore 22 from migrating into the valve 10 body 12. By preventing such ingress of debris into the valve 10 body the effective operational life of the valve is extended. Usable seals that may be configured for energization in accordance with the disclosed embodiments include those described in Intl. Pat. Apps. WO/2021/142004 and WO/2021/141999, both assigned to the present assignee and incorporated herein by reference.

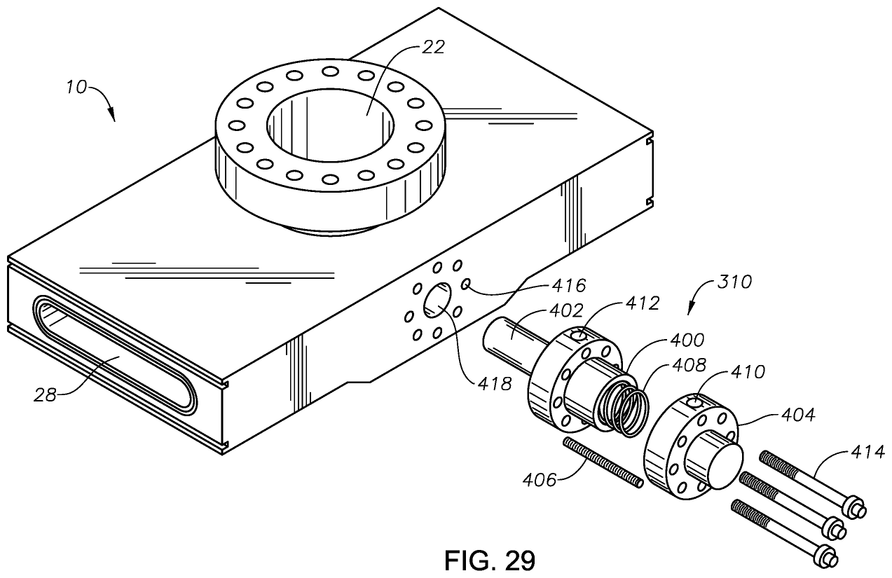

FIG. 29 shows an exploded view of a locking element 310 (see FIG. 18) in association with a valve 10. The locking element 310 includes a cylindrical body 400 with an internal passage that houses a sliding piston with an elongated shaft 402 extending from one end of the body. A cap 404 covers the distal end of the cylindrical body 400. The cap 404 is secured to the body 400 via a plurality of external bolts 406 coupling the two components together. The cylindrical body 400 also includes a spring 408 disposed between the cap 404 and the internal piston. In a static mode, the spring 408 applies force against the internal piston to maintain the elongated shaft 402 in the extended position. A first fluid port 410 on the cap 404 provides an inlet for fluid (e.g., hydraulic fluid) to push the internal piston toward the valve 10 wall, thereby fully extending the elongated shaft 402 from the cylindrical body 400. A second fluid port 412 on the cylindrical body 400 provides an inlet for fluid to push the piston from the other side, back into cylindrical body and thereby retracting the elongated shaft 402 from the valve 10 wall. In this embodiment, the locking element 310 is mounted to one side of the valve 10 body and affixed in place via a plurality of bolts 414 threaded into receptacles 416 formed on the side of the valve.

A port 418 is formed on the side of the valve 10 body 12 (see FIG. 18) and configured to permit the elongated shaft 402 to pass into the transverse passage 28 when it is extended from the locking element 310. Returning to FIG. 21, gate 26 embodiments implemented with orifices 348A, 348B formed on the side of the gate 26 are configured to receive the tip of the elongated shaft 402. As shown in FIG. 21, orifice 348A is located proximate the gate 26 opening 34 and 348B proximate the solid surface area 36. The orifices 348A, 348B are positioned on the gate 26 side such that when the gate 26 is in the open or closed position the positioned orifice aligns with the valve 10 port 418 to receive the elongated shaft 402 extending through the port.

FIG. 30 shows a plan view cross section of a valve 10 with the gate 26 in the open position. The locking element 310 is shown actuated such that the elongated shaft 402 is extended through the port 418 to engage gate 26 orifice 348A. In this state, the locking element 310 retains the gate 26 in the open position. To close the gate 26, the locking element 310 is actuated to retract the elongated shaft 402, thereby freeing the gate 26 for movement within the transverse passage 28. With such embodiments, the gate 26 remains securely in the open or closed position until the locking element 310 is actuated to retract the elongated shaft 402 to release the gate 26 as desired. It will be appreciated that valve 10 embodiments may be implemented with the locking element 310 configured for actuation via means other than fluid pressure (e.g., electric servo, electromagnet solenoid, pneumatic, ROV actuation, etc.).

An advantage of the disclosed valve 10 embodiments includes the implementation of a valve 10 that can be repaired/refurbished in the field, without needing to remove the valve unit from the operational system. Another advantage is the implementation of a valve 10 with the working components (e.g., seals) disposed in the gate 26, making it very easy and efficient to replace key components via a swappable gate cartridge. The disclosed valves 10 do not require any packing or grease filling as used with conventional stemmed valve designs. By providing seals on both surfaces of the gate 26, the valves 10 provide balanced upstream flow and downstream flow sealing between the gate and the body 12. The disclosed valves 10 prevent fugitive emissions when the valve is in the open or closed position and while the gate 26 is in transition.

It will be appreciated that embodiments of the disclosed valves 10 may be implemented for use in numerous applications and operations, in the oil and gas industry and in other fields of endeavor. For example, the disclosed valve 10 embodiments may be deployed for use at surface, above surface, subsurface, and under water. It will be appreciated by those skilled in the art that embodiments of this disclosure may be implemented with conventional hardware components (e.g., conventional fasteners, flanges, etc.) and parts formed of suitable materials depending on the application. It will also be appreciated that embodiments may be implemented with pressurized fluid (liquid/gas) components and control units locally or remotely linked to the valves 10 as known in the art. The control unit(s) may comprise any suitable microcomputer, processor, controllers, memory, and associated electronics, and may be programmed to activate and operate the valves 10 as described herein. In some embodiments, the control unit can be programmed to perform autonomous and automatic actuation of the valves and components as described herein. Power for the apparatus and valve 10 systems may also be implemented, for example, using conventional batteries as known in the art. Although only a few examples have been described in detail above, those skilled in the art will readily appreciate that many modifications are possible in the examples. Accordingly, all such modifications are intended to be included within the scope of this disclosure.

What is claimed is:

1. A valve comprising:
a body having a through bore for fluid passage therethrough;
the body having a plurality of passages transverse to the through bore;
at least two of the passages transverse to the through bore each having a gate disposed therein configured for motion along the transverse passage between a position to permit fluid flow along the through bore and a position to restrict fluid flow along the through bore; and
wherein each gate is configured for motion along the transverse passage in one direction in response to a first force acting on the gate and in another direction in response to a second force acting on the gate.

2. The valve of claim 1 wherein each gate comprises at least one seal to restrict fluid flow between the through bore and the respective transverse passage.

3. The valve of claim 1 wherein at least one gate comprises at least one seal configured for energization.

4. The valve of claim 1 wherein at least one gate is configured with a closed internal fluid circuit to energize and/or de-energize at least one seal disposed on the gate.

5. The valve of claim 4 wherein the at least one gate comprises at least one intensifier element to affect fluid pressure in the closed internal fluid circuit.

6. The valve of claim 1 wherein the body comprises at least one port formed thereon linked to the through bore.

7. The valve of claim 6 wherein the at least one port is disposed on the body between the at least two transverse passages having a gate disposed therein.

8. The valve of claim 7 wherein each gate disposed in the at least two transverse passages is configured for selective activation to permit fluid flow into or out of the through bore via the at least one port.

9. The valve of claim 7 wherein each gate disposed in the at least two transverse passages is configured for selective activation to restrict fluid flow via the through bore.

10. The valve of claim 7 wherein each gate disposed in the at least two transverse passages is configured for selective activation to affect fluid flow into or out of a first end or a second end of the through bore.

11. The valve of claim 1 wherein the body comprises at least one locking element to retain at least one gate in a selected position within the respective transverse passage.

12. The valve of claim 1 wherein the body is configured with multiple internal passages to channel fluid to apply the first force on each gate to move the gate along the respective transverse passage.

13. The valve of claim 12 wherein the body is configured with multiple internal passages to channel fluid to apply the second force on each gate in opposition to the first force to move the gate along the respective transverse passage.

14. The valve of claim 1 wherein at least one gate has a first surface and a second surface opposite the first surface, with a first seal disposed on the first surface and a second seal disposed on the second surface.

15. The valve of claim 14 wherein the at least one gate is configured with a closed internal fluid circuit to energize and/or de-energize the first seal and the second seal.

16. The valve of claim 1 wherein each gate is configured for motion free of any mechanical linkage.

17. A method of operating a valve having a body with a through bore for fluid passage therethrough and a plurality of passages transverse to the through bore, comprising:
actuating a first gate disposed in a first passage transverse to the through bore for motion in one direction via a first force acting on the first gate and in another direction via a second force acting on the first gate;
actuating a second gate disposed in a second passage transverse to the through bore for motion in one direction via a first force acting on the second gate and in another direction via a second force acting on the second gate;
wherein actuation of the first gate and/or the second gate affects fluid flow along the through bore.

18. The method of claim 17 wherein the valve body comprises at least one port formed thereon linked to the through bore.

19. The method of claim 18 wherein the actuation of the first gate and/or the second gate permits fluid flow into or out of the through bore via the at least one port.

20. The method of claim 17 wherein the actuation of the first gate and/or the second gate restricts fluid flow via the through bore.

21. The method of claim 17 wherein the actuation of the first gate and/or the second gate affects fluid flow into or out of a first end or a second end of the through bore.
